(19) United States
(12) Patent Application Publication
(10) Pub. No.: US 2024/0033784 A1
(43) Pub. Date: Feb. 1, 2024

(54) ADHESIVE REMOVAL TOOL

(71) Applicant: Ryan Curtis Werner DRESCHER, Calgary (CA)

(72) Inventor: Ryan Curtis Werner DRESCHER, Calgary (CA)

(21) Appl. No.: 17/873,372

(22) Filed: Jul. 26, 2022

(51) Int. Cl. B08B 1/00; B08B 1/04; B60S 3/04

(52) U.S. Cl. CPC B08B 1/005; B08B 1/04; B60S 3/048; B08B 2220/01; B25F 5/00

(57) ABSTRACT

An adhesive removal tool is provided. An adhesive removal tool for removing adhesive on painted and non-painted automotive parts comprising a bolt coupled through a center hole of rubber wheel via one or more fasteners. The bolt having a threaded portion below a head and meeting a shaft at a midpoint of the bolt and the rubber wheel having an upper lip and a lower lip surround the center hole, the upper lip and the lower lip are surrounded by a donut shaped ethylene propylene diene monomer (EPDM) rubber, wherein the head lies flush on the upper lip and the one or more fasteners lie flush against the lower lip when fastened to the threaded portion.

### FIELD OF THE INVENTION

The present disclosure relates to an adhesive removal tool, more specifically, but not by way of limitation, more particularly to a rubber wheel coupled to a fastener that is optionally coupling to a power tool for removing adhesive on painted and non-painted automotive parts.

### BACKGROUND

Any discussion of the related art throughout the specification should in no way be considered as an admission that such related art is widely known or forms part of common general knowledge in the field.

Currently there is no adhesive remover wheel on the market that is specifically made for moldings and current adhesive wheels do not remove adhesive from painted plastic panels without damaging the painted finish. Typically, a scrape with a razor and a degreaser is employed to remove adhesive, which tend to be fairly bulky and unable to get into tight crevices. Furthermore, exterior plastic body panels are on the rise and current adhesive wheels fail to remove adhesive without damaging paint.

U.S. Pub. No. 2006/0218739 A1 (Hsu) discloses a wheel having several equidistantly spaced apart gaps on each of the annular edges of two sides thereof, and a tooth-shaped portion between every two adjacent ones of the gaps; when the wheel is turned while being pressed against an object, which has adhesive on the surface, the adhesive will be removed; because the gaps are formed, when the wheel is used to remove adhesive from the surface of an object, the area of contact between the wheel and the object won't be too large, and in turn damage of the surface of the object is prevented, and the wheel will wear down more slowly. Shortcomings include a lack of durability, and the wheel isn't manufactured from EPDM to ensure prevention of damaging paint or plastic during the adhesive removal.

U.S. Pub. No. 2011/0225749 A1 (Wang) discloses an eraser wheel for cleaning viscose, which comprises an eraser wheel body and a coupling member. The eraser wheel body has an axial hole and a plurality of slots thereon. The axial hole is located at a central portion of the eraser wheel body. The slots are located beside the axial hole. The coupling member includes a coupling axle and a plurality of coupling ribs. One end of the coupling axle is provided with a connecting unit, and another end of the coupling axle is connected with the coupling ribs. The coupling axle is inserted through the axial hole. The coupling ribs are positioned in the slots. Accordingly, it is only required to replace with a new eraser wheel, without making a replacement of the coupling member. Besides, the eraser wheel can be produced alone, which simplifies the production procedure. Shortcomings include an inability to easily assemble and disassemble for maintenance and replacing parts, a lack of durability, the eraser isn't manufactured from EPDM to ensure prevention of damaging paint or plastic during the adhesive removal and the eraser isn't lightweight.

U.S. Pat. No. 5,259,914 A (Fisher) discloses a portable vehicle adhesive remover having a motor unit assembled inside a housing including a throttler, a rotor and a gear assembly where the motor unit has an elongated spindle extending out from the top opening of the housing; an extending shank having a proximal end attached to the elongated spindle of the motor unit and a distal end; and an eraser unit attached to the distal end of the extending shank including a resilient eraser member and a disc member embedded in the eraser member. When the eraser unit and the motor unit are attached and a high pressure compressed air is sent into the bottom opening of the housing, the compressed air will be gushed into the rotor by the throttler assembly, which in turn will drive the eraser unit through the gear assembly and cause the resilient eraser member to rotate at a high speed. When a high-speed rotating eraser member is engaged to pinstripes, decals, side moldings and other adhered items, it can generate adequate heat to cause the adhesive to lose its adhesion and thus release the pinstripes, decals, side moldings and other adhered items, so they can be removed without damaging the paint or other body parts of the vehicle. Shortcomings include an inability to easily assemble and disassemble for maintenance and replacing parts, a lack of durability, the portable vehicle adhesive remover isn't manufactured from EPDM to ensure prevention of damaging paint or plastic during the adhesive removal, lacks the ability to be operated manually and the portable vehicle adhesive remover isn't lightweight.

U.S. Pat. No. 5,856,396 A (Vipperman) discloses a method of manufacturing rubber wheels and composition therefor used on a portable vehicle adhesive remover for removing pinstripes, decals, side moldings and other items adhering to a vehicle without damaging the original paint of the vehicle. Shortcomings include an inability to easily assemble and disassemble for maintenance and replacing parts, a lack of durability, the rubber wheel isn't manufactured from EPDM to ensure prevention of damaging paint or plastic during the adhesive removal, lacks the ability to be operated manually and the portable vehicle adhesive remover isn't lightweight.

U.S. Pat. No. 5,879,504 A (Winter) discloses a soft elastomeric disc for removal of polymeric compositions from an underlying substrate. The disc is useful for removing decorative decals, stripes, graphics, emblems, protective moldings, paint and adhesive and is made from a filled elastomeric composition. The elastomeric composition is filled with a system that combines an organic lubricant and a non-abrasive particulate. Shortcomings include an inability to easily assemble and disassemble for maintenance and replacing parts, a lack of durability, the soft elastomeric disc isn't manufactured from EPDM to ensure prevention of damaging paint or plastic during the adhesive removal, lacks the ability to be operated manually and the soft elastomeric disc isn't compact enough to perform in tight spaces and isn't lightweight.

U.S. Pat. No. 7,904,989 B1 (Chen) discloses a rotary eraser assembly includes a rotary eraser, two discs, a threaded bolt and a nut. The rotary eraser includes, in each of two opposite sides, a cavity in communication with the aperture and at least one recess in the wall of the cavity. Each of the discs includes an annular lip disposed in the cavity in a related one of the sides of the rotary eraser and at least one block disposed in the recess in the related side of the rotary eraser. The threaded bolt is inserted through the rotary eraser and the discs. The nut is engaged with threaded bolt. Shortcomings include an inability to easily assemble and disassemble for maintenance and replacing parts, a lack of durability, the rotary eraser isn't manufactured from EPDM to ensure prevention of damaging paint or plastic during the adhesive removal and isn't lightweight.

U.S. Pat. No. 8,007,347 B1 (Lampka et al.) discloses a rotary abrading tool of the erasure-type. The invention includes a wheel assembly comprising an annular eraser wheel having an outer crown of radially directed teeth, a central core of an elastomeric material that radially expands during operation, and a pair of discoid hubs secured on opposite axial ends of the eraser wheel. The teeth of the eraser wheel are helically arranged. Shortcomings include an inability to easily assemble and disassemble for maintenance and replacing parts, a lack of durability, the rotary abrading tool isn't manufactured from EPDM to ensure prevention of damaging paint or plastic during the adhesive removal, lacks the ability to be operated manually and the rotary abrading tool isn't lightweight.

U.S. Pat. No. 8,286,291 B2 (Lampka et al.) discloses a two-piece eraser assembly, including an eraser disk and an eraser hub for mounting and holding the eraser disk. The eraser hub includes upper and lower surfaces a flange at the peripheral edge of the hub and a stub shaft on the lower surface positioned axially with a through bore. The eraser hub includes a plurality of spaced apertures for engaging with and detachably locking eraser disk extensions on the backside. The upper surface of the eraser disk includes a central recess and an aperture in the recess. The eraser disk includes a plurality of abrading teeth running radially from the central recess. The lower surface of the eraser disk further comprises a plurality of mounting elevations keyed for engaging with the spaced apertures or slots in the eraser hub for securely locking the eraser disk to the eraser hub. Shortcomings include an inability to easily assemble and disassemble for maintenance and replacing parts, a lack of durability and a time efficient operation, the two piece eraser assembly isn't manufactured from EPDM to ensure prevention of damaging paint or plastic during the adhesive removal, lacks the ability to be operated manually, the two piece eraser assembly isn't compact enough to perform in tight spaces and isn't lightweight.

U.S. Pat. No. 9,399,313 B1 (Vipperman) discloses an improved method of manufacturing rubber wheels and composition thereof used on a portable vehicle adhesive remover for removing pinstripes, decals, side moldings and other items adhering to a vehicle without damaging the original paint of the vehicle. The improved method of manufacturing rubber wheels may comprise masticating approximately 100 parts of rubber in a mixer and synthesizing a rubber compound by mixing in at least 8 parts of activating agents, less than 60 parts of processing oil, between 0.1% and 1.5% by parts of cross-linking agent, and at least 1 part accelerating agent. The improved method may also comprise vulcanizing the synthesized rubber compound in a mold to produce a rubber wheel having a Shore A hardness between 50 and 60. Shortcomings include an inability to easily assemble and disassemble for maintenance and replacing parts, a lack of durability, the portable vehicle adhesive remover isn't manufactured from EPDM to ensure prevention of damaging paint or plastic during the adhesive removal, lacks the ability to be operated manually and the portable vehicle adhesive remover isn't lightweight.

All documents cited herein are incorporated by reference.

It is clear that there exists a need for an adhesive removal tool for removing adhesive on painted and non-painted automotive parts. There is need for an adhesive removal tool that is easily assembled and disassembled for maintenance and replacing parts, that has excellent longevity, that speeds up the time required to remove the adhesive, that is made from an EPDM rubber (ethylene propylene diene monomer rubber) to prevent damaging paint or plastic during the adhesive removal, that can be manually operated or automatically operated through coupling the adhesive tool to a power tool, that is small enough to get into tight cervices and lightweight for reducing strain when working in uncomfortable positions.

### BRIEF SUMMARY

It is an object of the invention to provide an adhesive removal tool.

In accordance with an aspect of the invention, there is provided an adhesive removal tool for removing adhesive on painted and non-painted automotive parts comprising a bolt coupled through a center hole of rubber wheel via one or more fasteners. The bolt having a threaded portion below a head and meeting a shaft at a midpoint of the bolt and the rubber wheel having an upper lip and a lower lip surround the center hole, the upper lip and the lower lip are surrounded by a donut shaped ethylene propylene diene monomer (EPDM) rubber, wherein the head lies flush on the upper lip and the one or more fasteners lie flush against the lower lip when fastened to the threaded portion.

In accordance with an embodiment of the invention, the adhesive removal tool is optionally coupled to a power tool via the shaft.

In accordance with an embodiment of the invention, the bolt is composed of steel.

In accordance with an embodiment of the invention, the one or more fasteners is a nut.

In accordance with an embodiment of the invention, the nut is composed of steel.

In accordance with an embodiment of the invention, the one or more fasteners is a washer.

In accordance with an embodiment of the invention, the washer is composed of steel.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

In the figures, embodiments are illustrated by way of example. It is to be expressly understood that the description and figures are only for the purpose of illustration and as an aid to understanding.

Embodiments will now be described, by way of example only, with reference to the attached figures, wherein the figures:

FIG. 1A illustrates an aspect of the subject matter in accordance with one embodiment.

FIG. 1B illustrates an aspect of the subject matter in accordance with one embodiment.

FIG. 2A illustrates an aspect of the subject matter in accordance with one embodiment.

FIG. 2B illustrates an aspect of the subject matter in accordance with one embodiment.

FIG. 3A illustrates an aspect of the subject matter in accordance with one embodiment.

FIG. 3B illustrates an aspect of the subject matter in accordance with one embodiment.

FIG. 3C illustrates an aspect of the subject matter in accordance with one embodiment.

### DETAILED DESCRIPTION

The details of one or more embodiments of the subject matter of this specification are set forth in the accompanying drawings and the description below. Other features, aspects, and advantages of the subject matter will become apparent from the description, the drawings, and the claims.

Like reference numbers and designations in the various drawings indicate like elements.

The disclosure proposes an adhesive removal tool for removing adhesive on painted and non-painted automotive parts that overcomes disadvantages inherent in the existing adhesive removal tools. The present invention provides an adhesive removal tool that may be used with many different embodiments. As such, the general purpose of the present invention, which will be described subsequently in greater detail, is to provide a new and improved adhesive removal tool for removing adhesive on painted and non-painted automotive parts, which provides the advantages and overcomes the aforementioned disadvantages.

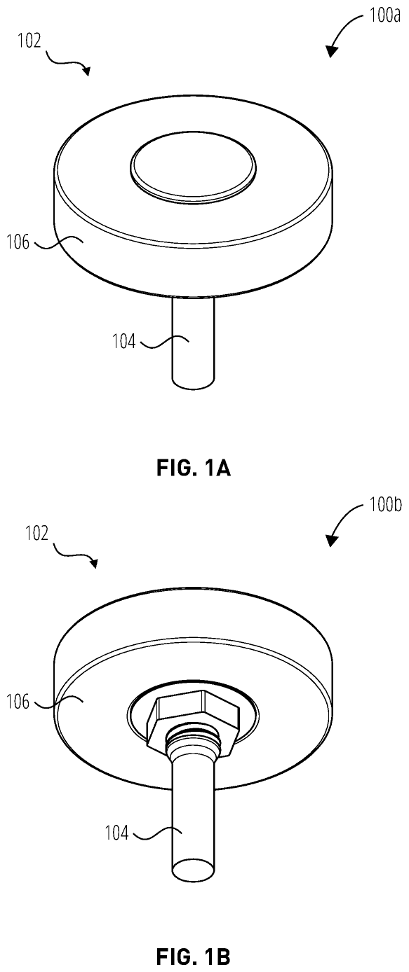

FIG. 1A illustrates a top perspective view 100a of an adhesive removal tool 102, according to some embodiments. The adhesive removal tool 102 is employed for removing adhesive on painted and non-painted automotive parts. The adhesive removal tool 102 is shown comprising a bolt 104 coupled through a center hole, not currently shown, of a rubber wheel 106 via a fastener, not currently shown.

FIG. 1B illustrates a bottom perspective view 100b of an adhesive removal tool 102, according to some embodiments. The adhesive removal tool 102 can be employed manually for the removal of adhesive from moldings and other small plastic automotive parts. The adhesive removal tool 102 is lightweight and compact, which sufficiently reduces strain when working in uncomfortable positions and allows for employing the adhesive removal tool 102 in tight crevices.

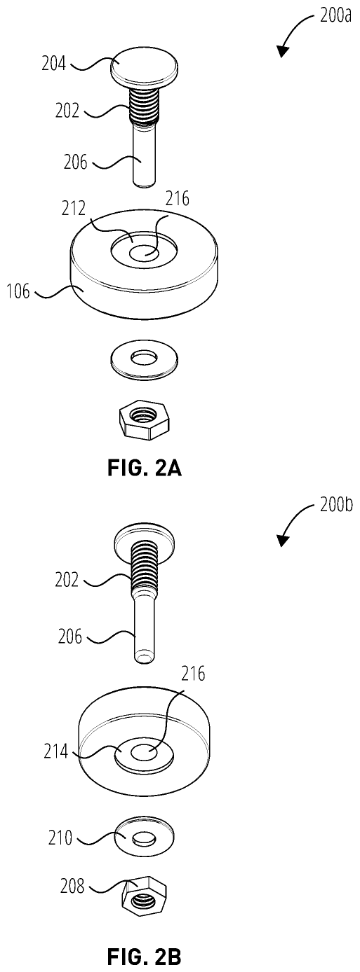

FIG. 2A illustrates a top perspective exploded view 200a of an adhesive removal tool 102, according to some embodiments. In the embodiment shown, a bolt 104 is displayed having a threaded portion 202 below a head 204 and connected to a shaft 206 at a midpoint of the bolt 104. In some embodiments, one or more of the bolt 104, the nut 208 or the washer 210 is composed of steel, which adds to the durability of the adhesive removal tool 102.

Furthermore, the rubber wheel 106 is displayed having an upper lip 212 and a lower lip 214 surround the center hole 216, where the upper lip 212 and the lower lip 214 are surrounded by a donut shaped ethylene propylene diene monomer (EPDM) rubber. The EPDM rubber allows for the removal of the adhesive while preventing damaging of the paint or plastic surface that the adhesive is being removed from, while adding to the durability of the adhesive removal tool 102. In some embodiments, the rubber wheel 106 is composed of alternative monomers or polymers, such as, but not limited to a nitrile butadiene rubber (NBR). Once assembled, the head 204 of the bolt 104 lies flush on the upper lip 212 of the rubber wheel 106.

FIG. 2B illustrates a bottom perspective exploded view 200b of an adhesive removal tool 102, according to some embodiments. Once assembled, the fastener, currently shown as the washer 210, lies flush against the lower lip 214 of the rubber wheel 106 with the nut 208 fastened to the threaded portion 202 against the washer 210. The quick and easy assembly and disassembly facilitates routine maintenance and allows the user to effortlessly replace parts.

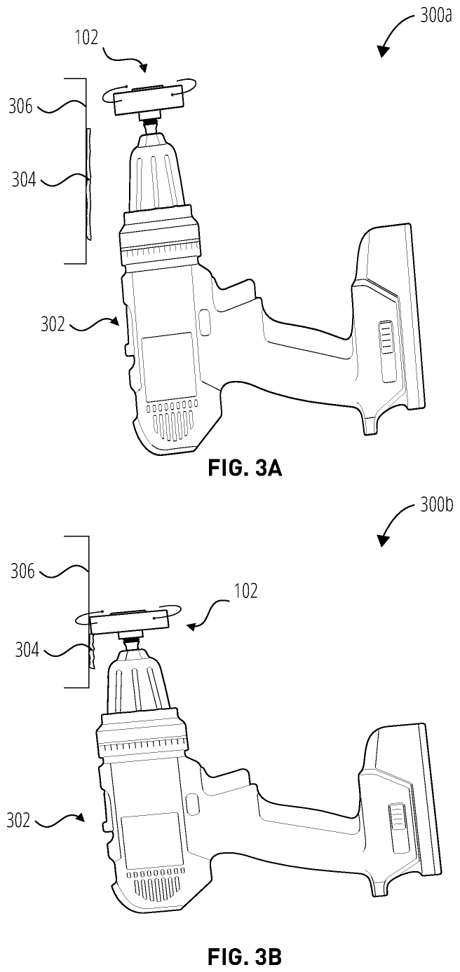

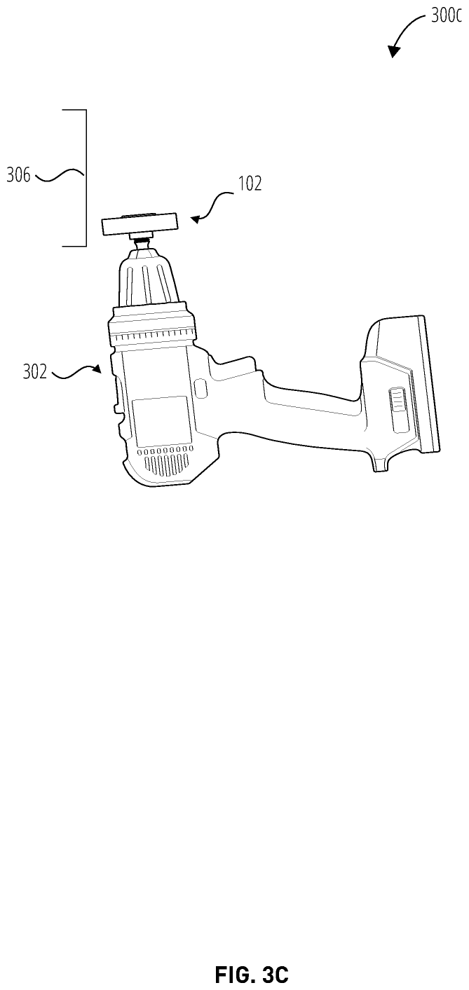

FIG. 3A illustrates a first applied view 300a of an adhesive removal tool 102, according to some embodiments. In the embodiment shown, the adhesive removal tool 102 is optionally coupled to a power tool 302 via the shaft 206. By coupling the adhesive removal tool 102 to the power tool 302, the adhesive removal tool 102 is automatically rotated via the power tool 302 and the rotations per minute are greatly increased as compared to manual operation of the adhesive removal tool 102, which greatly speeds up the removal of adhesive 304 from moldings and other small plastic automotive parts.

In the embodiment shown, an adhesive 304 is affixed to an automotive surface 306 and the adhesive removal tool 102 is coupled to the power tool 302. The power tool 302 is being powered to rotate the adhesive removal tool 102 while the user lines up the edge of the rubber wheel 106 to the adhesive 304. The end of the shaft 206 may be shaped to fit a variety of power tools 302 in order to be received and couple to the chuck of the power tool 302. An example of the shape of the end of the shaft 206 include but is not limited to hexagonal.

FIG. 3B illustrates a second applied view 300b of an adhesive removal tool 102, according to some embodiments. In the embodiment shown, the rubber wheel 106 is engaged with the adhesive 304 and is gently removing the adhesive 304 off of the automotive surface 306. In some embodiments, the diameter of the rubber wheel 106 is larger than the diameter of the power tool 302 such that the rubber wheel 106 is in contact with the automotive surface 306 at the vertical as opposed to at an angle as shown in FIG. 3B.

FIG. 3C illustrates a third applied view 300c of an adhesive removal tool 102, according to some embodiments. In the embodiment shown, the rubber wheel 106 has completely removed the adhesive 304 from the automotive surface 306 without scratching or peeling the automotive surface 306.

The foregoing descriptions of specific embodiments of the present invention have been presented for purposes of illustration and description. They are not intended to be exhaustive or to limit the invention and method of use to the precise forms disclosed. Obviously, many modifications and variations are possible in light of the above teaching. As can be understood, the examples described above are intended to be exemplary only.

The embodiments described were chosen and described in order to best explain the principles of the invention and its practical application, and to thereby enable others skilled in the art to best utilize the invention and various embodiments with various modifications as are suited to the particular use contemplated. It is understood that various omissions or substitutions of equivalents are contemplated as circumstance may suggest or render expedient but is intended to cover the application or implementation without departing from the spirit or scope of the claims of the present invention.

The term “connected”, “attached”, “affixed” or “coupled to” may include both direct coupling (in which two elements that are coupled to each other contact each other) and indirect coupling (in which at least one additional element is located between the two elements).

As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

What is claimed is:

1. An adhesive removal tool for removing adhesive on painted and non-painted automotive parts comprising:
a bolt coupled through a center hole of rubber wheel via one or more fasteners;
said bolt having a threaded portion below a head and meeting a shaft at a midpoint of said bolt; and
said rubber wheel having an upper lip and a lower lip surround said center hole, said upper lip and said lower lip are surrounded by a donut shaped ethylene propylene diene monomer (EPDM) rubber, wherein said head lies flush on said upper lip and said one or more fasteners lie flush against said lower lip when fastened to said threaded portion.

2. The adhesive removal tool of claim 1, wherein said adhesive removal tool is optionally coupled to a power tool via said shaft.

3. The adhesive removal tool of claim 1, wherein said bolt is composed of steel.

4. The adhesive removal tool of claim 1, wherein said one or more fasteners is a nut.

5. The adhesive removal tool of claim 4, wherein said nut is composed of steel.

6. The adhesive removal tool of claim 1, wherein said one or more fasteners is a washer.

7. The adhesive removal tool of claim 6, wherein said washer is composed of steel.
